(19) United States
(12) Patent Application Publication
(10) Pub. No.: US 2002/0131922 A1
(43) Pub. Date: Sep. 19, 2002

(54) Reactor having catalyst-unloading structure

(76) Inventor: Kenji Sakai, Chiba (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/100,632

(22) Filed: Mar. 14, 2002

(30) Foreign Application Priority Data
Mar. 16, 2001 (JP) 2001-076200

(51) Int. Cl. B01J 8/06; B01L 7/00

(52) U.S. Cl. 422/198; 422/201; 422/192

(57) ABSTRACT

A reactor for gas-phase reaction having a catalyst-unloading structure, comprising:

a vertical center pipe for feeding a raw material gas; an annular space around the pipe for containing a catalyst; vertical heat exchanger tubes in the space; a means for collecting a product gas outside the space; an opening for unloading the catalyst at the bottom of the pipe; and an inner cylinder contacting with the inner surface of the pipe slidably for preventing the catalyst passage from passing through the opening, wherein,

the cylinder has throughholes of a size allowing no passing of the catalyst on its periphery; a support ring for supporting the cylinder is provided at the lower end of the pipe; the cylinder is inserted inside the pipe and placed on the support ring; and the cylinder is equipped with a means for pushing the cylinder upward to open the opening.

### BACKGROUND OF THE INVENTION

1. Field of the Invention

The present invention relates to a reactor packed with a catalyst for an exothermic or endothermic reaction such as methanol synthesis, ammonia synthesis, methanation reaction, hydrocarbon reforming or the like, and particularly to a reactor having an improved structure for catalyst unloading.

### DISCUSSION OF THE BACKGROUND

In a reactor using a catalyst, it is necessary to unload the catalyst from the reactor for exchange with a fresh catalyst when the reactor has been operated for a given length of time and the catalyst life has expired. As the structure for unloading the spent catalyst, there have been known various structures which are different depending upon the type of the reactor. Catalyst unloading is ordinarily conducted through a nozzle stub (a nozzle) fitted to the bottom of the outer surface of the reactor. For example, JP-A-10-277382 and JP-A-10-277383 propose a method for catalyst unloading from a reactor for methanol synthesis. According to the method disclosed in these literatures, the reactor is constituted by a plurality of double pipes; a catalyst is packed in the annular portion of each double pipe; and the spent catalyst is collected from the annular part of each double pipe into a collecting chamber located at the bottom of the reactor and is unloaded from the collecting chamber.

However, when a large number of heat exchanger tubes for removing or supplying reaction heat are inserted into the catalyst layer, the heat exchanger tubes become an obstacle and, in some cases, the catalyst present in the central portion of the reactor is not discharged sufficiently. In order to solve this problem, Patent No. 2547278 (JP-A-4-180827) proposes a method wherein, as shown in FIG. 3, an inner cylinder 22 is provided at the bottom of a center pipe 21, there is formed, by lowering the inner cylinder, an opening 23 at the bottom of the center piper 21, and a catalyst is unloaded completely from the center of the bottom of a catalyst layer of a reactor.

In employing the catalyst-unloading structure described in the above Patent No. 2547278 (JP-A-4-180827), there were cases that the catalyst which had broken or become particulates or a fine powder during the operation of the reactor, moved to the lower part of the catalyst layer owing to its own weight, and penetrated into the sliding part between the center pipe and the inner cylinder, which caused a large resistance in lowering the inner cylinder and made it difficult to form the opening. There were also cases that in unloading the catalyst and then returning the inner cylinder to the original position, the movement of the inner cylinder had to be made against a large resistance.

In unloading a catalyst which is oxidized upon contact with the air and generates a heat, it is necessary to control the amount of the catalyst to be unloaded so that the catalyst unloaded outside a reactor can be handled appropriately and safely. In the conventional method, however, it was necessary to close the once-opened opening against a large resistance in some cases, as mentioned above; in such cases, it was necessary to additionally provide, for example, a control valve or diaphragm at a site where the catalyst leaves the reactor.

### SUMMARY OF THE INVENTION

An object of the present invention is to provide a gas-phase reactor having an improved structure for catalyst unloading which makes the catalyst-unloading operation easy and safe.

The above object of the present invention can be achieved by the following reactor. That is, the reactor having an improved structure for catalyst unloading according to the present invention is a reactor for gas-phase reaction, having a catalyst-unloading structure, which comprises:

a center pipe for feeding a raw material gas in the radial direction of the reactor or for collecting a reaction product gas, said center pipe being provided vertically,

an annular space for packing a catalyst therein, said annular space being provided around the center pipe,

a plurality of heat exchanger tubes for allowing a heat transfer medium for cooling or heating to flow therethrough, said heat exchanger tubes being provided vertically in the annular space,

a means for collecting a reaction product gas or feeding a raw material gas in the radial direction of the reactor, said means being provided outside the annular space,

an opening for unloading the catalyst packed in the annular space, said opening being provided at the bottom of the center pipe, and

an inner cylinder for preventing the catalyst from passing through the opening, said inner cylinder contacting with the inner surface of the center pipe slidably,

wherein,

the inner cylinder has no opening or has openings of a size allowing no passing of the catalyst, on the periphery thereof,

a support ring for supporting the inner cylinder is provided at the lower end of the center pipe,

the inner cylinder is inserted inside the center pipe and is placed on the support ring, and

the inner cylinder is equipped with a push-up means for pushing the inner cylinder upward to open the opening of the center pipe and for allowing the inner cylinder to descend by the own weight of the inner cylinder to close the opening of the center pipe.

### BRIEF DESCRIPTION OF THE DRAWINGS

FIG. 1 is a schematic view showing an embodiment of the reactor of the present invention.

FIG. 2 is an enlarged view of the center pipe bottom and its vicinity of the reactor shown in FIG. 1.

FIG. 3 is a schematic view showing a conventional reactor having a catalyst-unloading structure.

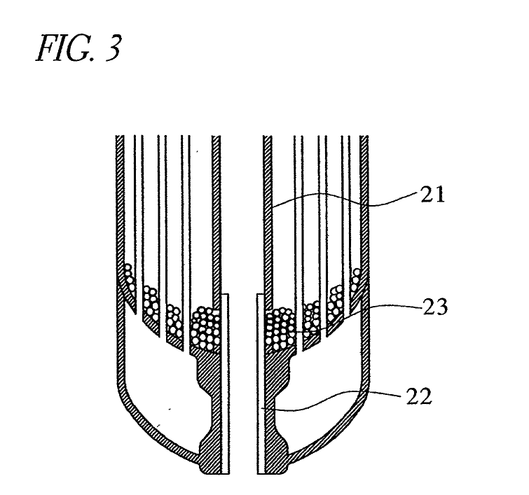

### DETAILED DESCRIPTION OF THE INVENTION

The reactor of the present invention will be described in detail below.

In the reactor of the present invention is provided, vertically at the center, a center pipe for feeding a raw material gas in the radial direction of the reactor or for collecting a reaction product gas. In the annular space present between the outer circumference of the center pipe and the inner circumference of the reactor is packed a catalyst to form a catalyst layer. A raw material gas for reaction passes through the catalyst layer in the radial direction of the reactor, whereby a reaction is allowed to take place. The portion of the center pipe contacting with the catalyst layer can be composed of a profile wire screen, a wire netting screen or a screen having cylindrical structure in order to hold the catalyst layer but not to prevent the passage of gas. Alternatively, the portion of the center pipe contacting with the catalyst layer may be composed of a combination of a) a perforated pipe allowing uniform inflow or discharge of raw material gas or reaction product gas and b) the above-mentioned screen.

In the catalyst layer are vertically provided a plurality of heat exchanger tubes through which a heat transfer medium for removing or supplying a reaction heat flows.

It is preferred that an annular space is provided between the outer side of the catalyst layer and the inner wall of the reactor by providing, outside the catalyst layer, for example, a screen or a combination of a screen and a perforated cylinder and further a raw material gas inlet or a reaction product gas outlet is provided so as to communicate with the annular space, whereby the uniform feeding of a raw material gas in the radial direction of the reactor or the discharging of a reaction product gas is made. Besides such a structure, structures used in this technical field can be widely employed.

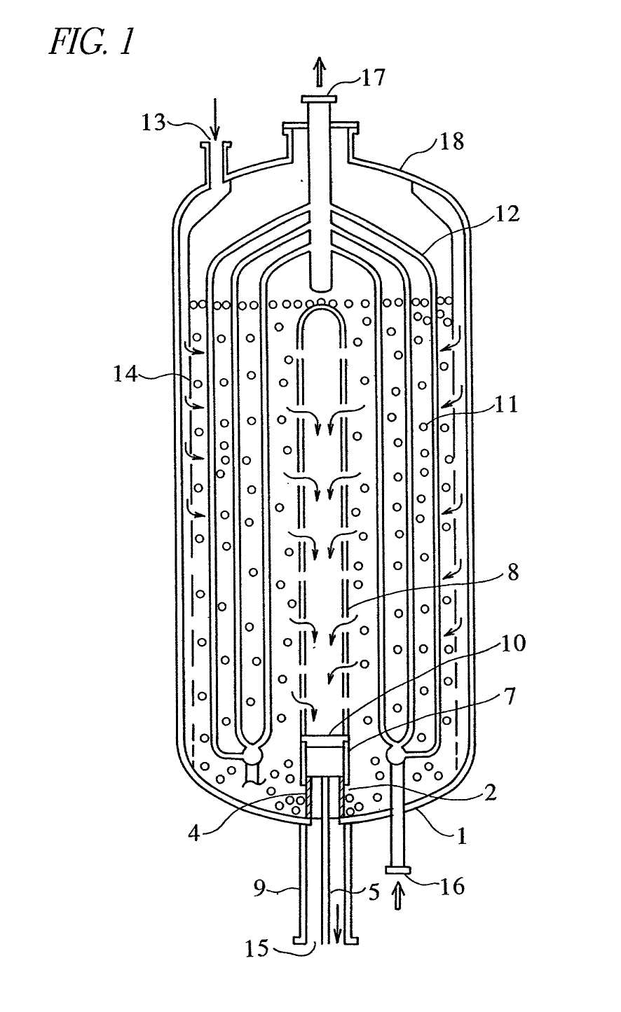

In a reactor 18 which is an embodiment of the present invention shown in FIG. 1, a center pipe 8 for collecting a reaction product gas is provided vertically; a catalyst layer 11 is provided in an annular space surrounding the center pipe; and a plurality of heat exchanger tubes 12 are provided in the annular space. A screen 14 is provided outside the annular space, whereby is formed a means for feeding a raw material gas in the radial direction of the reactor. A raw material gas introduced from an raw material gas inlet 13 is fed by the screen 14 into the annular space in the radial direction of the reactor and reacts in the catalyst layer 11. The resulting reaction product gas is collected by the center pipe 8 and is discharged from a reaction product gas outlet 15. Meanwhile, a heat transfer medium is fed from a heat transfer medium inlet 16, is passed through the heat exchanger tubes 12, and is discharged from a heat transfer medium outlet 17.

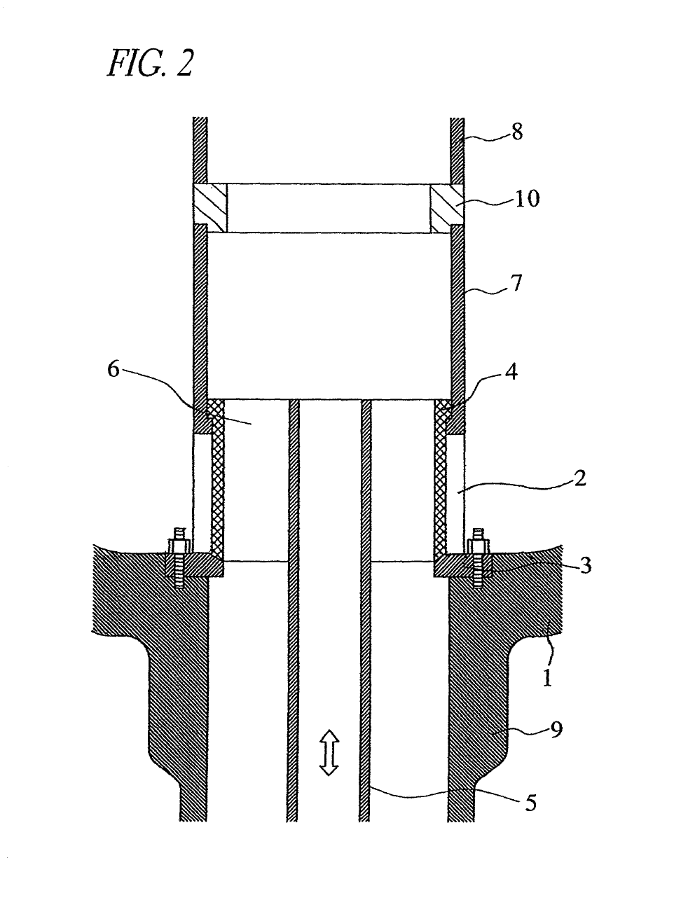

Then, description is made on the catalyst-unloading structure of the above reactor with reference to FIG. 2. For enabling catalyst unloading, an opening 2 for catalyst unloading is provided at the bottom of the center pipe 8. In the embodiment shown in FIG. 2, the center pipe 8 has, at the bottom, an intermediate flange 10 and also a cylinder 7 having an opening 2. The center pipe need not be constituted using these members as described above; an embodiment is possible in which the center pipe has the cylinder 7 directly atached at the bottom, and an embodiment is also possible in which the center pipe is made of one member including the part illustrated as cylinder 7 in FIG. 2. In the embodiment illustrated in FIG. 2 in which the center pipe has the intermediate flange 10 and the cylinder 7, the center pipe can be easily divided when desired; therefore, such an embodiment is preferred from the standpoint of easy assembling and maintenance. The upper part of the cylinder 7 may have a structure which enables the uniform feeding or discharging of raw material gas or reaction product gas as mentioned above, or may be a simple cylinder having no throughholes in the wall. The former structure can make higher the space efficiency in the reactor.

At the lower end of the center pipe is provided a support ring 3 for inner cylinder, having an inner diameter smaller than that of the center pipe 8. In the embodiment shown in FIG. 2 is provided a support ring 3 for inner cylinder, having an inner diameter smaller than that of the cylinder 7 (the lower part of the center pipe). The lower end of the center pipe 8 is fixed on an end plate or tube sheet 1 which constitutes the bottom part of the reactor body, with bolts or by other appropriate means.

Into the center pipe (the cylinder 7 in FIG. 2) is inserted, so as to slidably contact therewith, an inner cylinder 4 having no throughhole in the wall or having throughholes of a size allowing no passing of catalyst therethrough, and the lower end of the inner cylinder 4 is supported by the support ring 3 for inner cylinder. With an inner cylinder having, in the wall, throughholes of a size allowing no passing of catalyst therethrough, the space of the reactor can be utilized efficiently.

The inner cylinder 4 provided on the support ring 3 is pressed onto the support ring 3 by its own weight and the opening 2 is ordinarily in a closed state. The inner cylinder 4 does not descend lower than this position owing to the presence of the support ring 3.

The opening 2 is allowed to be in an open state by pushing the inner cylinder 4 upward. The push-up means for upward pushing the inner cylinder 4 may comprise a push pipe or rod 5. This pipe or rod is fixed to the inner wall of the inner cylinder 4 by means of an appropriate rib plate or other appropriate connecting means. When the push pipe or rod 5 is insufficient in length in an actual pushing of the inner cylinder 4, another appropriate pipe or rod may be added thereto.

When the inner cylinder 4 is pushed upward and the opening 2 is allowed to be in an open state, the catalyst from the catalyst layer 11 passes, owing to its own weight, through the opening 2 and further through a nozzle stub 9 which is connected to the end plate or tube sheet, and is discharged. When the discharging is finished, the upward pushing of the inner cylinder 4 is stopped; then, the lower end of the inner cylinder 4 descends onto the support ring 3 owing to the own weight of the inner cylinder.

Thus, in the above embodiment, the push-up means for upward pushing the inner cylinder 4 comprises a push pipe or rod 5 and the connecting means such as rib plate 6. The inner cylinder 4 and the push-up means form an opening and closing means for opening or closing the opening of the center pipe.

The reactor of the present invention employs a structure in which the opening for catalyst unloading is opened when the inner cylinder is pushed upward, and the sliding area between the inner cylinder and the center pipe is located above the opening. Therefore, the catalyst which has broken or become particulates or a fine powder during the operation of the reactor, descends downward owing to the own weight, only accumulates around the sealing area between the inner cylinder and the support ring where the catalyst contacts with the inner cylinder, and hardly penetrates into the sliding area. As a result, in the catalyst unloading after the operation of the reactor, the opening and closing of the opening 2 can be made under an extremely low resistance.

The opening for catalyst unloading can be closed only by the own weight of the inner cylinder; therefore, if closing of the opening is necessary after the start of catalyst unloading, the upward pushing of the inner cylinder is stopped and the opening can be closed easily. Thus, since the opening for catalyst unloading is easily opened and closed, catalyst unloading can be carried out easily and safely.

In unloading a catalyst which is oxidized upon contact with the air and generates a heat, it is necessary to control the amount of the catalyst to be unloaded so that the catalyst unloaded outside a reactor can be handled appropriately and safely. Even in such case, in the reactor of the present invention, since the opening for catalyst unloading can be opened and closed freely and easily as described above, it is not necessary to provide a control valve and the like.

What is claimed is:

1. A reactor for gas-phase reaction, having a catalyst-unloading structure, which comprises:
a center pipe for feeding a raw material gas in the radial direction of the reactor or for collecting a reaction product gas, said center pipe being provided vertically,
an annular space for packing a catalyst therein, said annular space being provided around the center pipe,
a plurality of heat exchanger tubes for allowing a heat transfer medium for cooling or heating to flow therethrough, said heat exchanger tubes being provided vertically in the annular space, a means for collecting a reaction product gas or feeding a raw material gas in the radial direction of the reactor, said means being provided outside the annular space,
an opening for unloading the catalyst packed in the annular space, said opening being provided at the bottom of the center pipe, and
an inner cylinder for preventing the catalyst from passing through the opening, said inner cylinder contacting with the inner surface of the center pipe slidably,
wherein,
the inner cylinder has no throughhole or has throughholes of a size allowing no passing of the catalyst, on the periphery thereof,
a support ring for supporting the inner cylinder is provided at the lower end of the center pipe,
the inner cylinder is inserted inside the center pipe and is placed on the support ring, and
the inner cylinder is equipped with a push-up means for pushing the inner cylinder upward to open the opening of the center pipe and for allowing the inner cylinder to descend by the own weight of the inner cylinder to close the opening of the center pipe.
